(19) United States
(12) Patent Application Publication
(10) Pub. No.: US 2026/0227520 A1
(43) Pub. Date: Aug. 6, 2026

(54) NAVIGATION METHOD WITH INVARIANT EXTENDED KALMAN FILTER AND VEHICLE EQUIPPED TO IMPLEMENT SAME

(71) Applicant: SAFRAN, PARIS (FR)

(72) Inventors: Camille CHAPDELAINE, MOISSY-CRAMAYEL (FR); Olivier BRUNE, MOISSY-CRAMAYEL (FR); Olivier GARCIA, MOISSY-CRAMAYEL (FR)

(21) Appl. No.: 19/158,282

(22) PCT Filed: Feb. 9, 2024
(86) PCT No.: PCT/EP2024/053355

§ 371 Date: Aug. 20, 2025

(30) Foreign Application Priority Data
Feb. 21, 2023 (FR) FR2301580

(51) Int. Cl. G01S 17/931; B64U 20/80; G01C 21/16; G01S 17/933; G05D 1/242; G05D 1/245; G05D 109/20

(52) U.S. Cl. CPC G01S 17/931; B64U 20/80; G01C 21/1652; G01S 17/933; G05D 1/242; G05D 1/245; B64U 2201/10; G05D 2109/20

(57) ABSTRACT

In a method for navigating a vehicle provided with a LiDAR and an inertial measurement unit, both connected to an electronic navigation unit that implements a first simultaneous localization and mapping algorithm and a second data merging algorithm, the first algorithm receiving, as an input, first location data from the LiDAR in order to calculate a first displacement from an initialisation position, the second algorithm receiving, as an input, the first displacement and second location data from the inertial measurement unit and outputting a merged second position of the vehicle, the second algorithm implements invariant extended Kalman filtering and in that the merged second position is introduced into a feedback loop which feeds into the first algorithm as an input in order to calculate a new position, which becomes the initialisation position.

The present invention relates to the field of vehicle navigation.

### BACKGROUND OF THE INVENTION

Vehicles provided with a LiDAR connected to an electronic navigation unit are known. It is noted that a LiDAR is an apparatus most often comprising a laser emitter and a photodetector which are mounted on a support that can be controlled in terms of its bearing. The laser emitter is arranged to emit laser pulses incident at predetermined bearing angles, and the photodetector detects the laser pulses reflected by obstacles surrounding the vehicle. From the bearing angle and a measurement of the time between the emission of the laser pulse and the detection of the reflected laser pulse, it is possible to determine the position of the obstacle relative to the laser emitter/photodetector assembly. As the laser emitter/photodetector assembly scans the vehicle environment, an image (commonly referred to as a LiDAR scan) of the vehicle environment is obtained, composed of the coordinates of all the reflection points of the laser pulses. The electronic navigation unit preferably implements a simultaneous localization and mapping algorithm (commonly referred to as SLAM), which aggregates the LiDAR scans to both map the environment in which the vehicle is moving and also determine the trajectory followed by the vehicle in the environment thus mapped, by detecting the presence of the same points of interest in successive LiDAR scans.

Vehicles provided with an inertial measurement unit connected to an electronic navigation unit are also known. It is noted that an inertial measurement unit (IMU) comprises three acceleration sensors arranged along the axes of an acceleration measurement reference frame and three angle sensors, which may be gyros or rate gyros, for measuring angular movements of the acceleration measurement reference frame relative to a reference orientation of the measurement reference frame. In the acceleration measurement reference frame, the acceleration sensors, which are exposed to gravity and the vehicle accelerations, measure a parameter referred to as specific force or g-force and determine the three components of a specific force vector. The signals from the sensors of the inertial measurement unit (acceleration and angle data) are used by an inertial navigation algorithm to determine, on the basis of said signals, a position of the vehicle in a local geographical reference frame.

Also known are vehicles provided with a LiDAR and an inertial measurement unit, both connected to an electronic navigation unit. Between two LiDAR scans, it is then possible to calculate intermediate positions from the only location data (“acceleration, angular velocity”), which are available at a higher frequency than the LiDAR scans.

FIG. 1 shows a first possible architecture of the electronic navigation unit combining LiDAR data and inertial data. The electronic navigation unit implements a first simultaneous localization and mapping algorithm, “SLAM”, and a second data merging algorithm, “Merging”. As an input, the first algorithm receives first location data, “LiDAR scans”, from the LiDAR in order to calculate a first current position and a first displacement, “yₙ”, between the first current position and an initialisation position. As an input, the second algorithm receives the first displacement, “yₙ” and second location data, “Acceleration, angular velocity”, from the inertial measurement unit in order to output a merged position of the vehicle for determining the trajectory, “Trajectory xₙ”, thereof.

For this first architecture, the merging of the location data of the LiDAR and the location data of the inertial measurement unit is referred to as being loose because the second merging algorithm does not directly process the LiDAR scans but rather a displacement determined on the basis of said LiDAR scans. This loose merging consumes few computing resources and memory but is sensitive to sudden vehicle movements, which may lead to blurring or to the loss of points of interest, which may alter the navigation accuracy.

To remedy these drawbacks, a second architecture has been devised (shown in FIG. 2) which tightly merges the location data of the LiDAR and the location data of the inertial measurement unit. The electronic navigation unit then implements a data merging algorithm which receives, as an input, both the first location data, “LiDAR scans”, from the LiDAR directly and also the second location data, “Acceleration, angular velocity”, from the inertial measurement unit, which, as before, outputs a merged position of the vehicle for determining the trajectory, “Trajectory xₙ”, thereof. The data merging algorithm implements iterated Kalman filtering which merges, in a large dimension vector, a state of the vehicle, which corresponds to the second location data, with the coordinates of the laser pulse reflection points, which correspond to the first location data.

Tight merging brings a significant gain in precision but consumes lots of computational resources and memory. In addition, performing the calculations requires a significant amount of energy, which is drawn from the energy stored in the vehicle. When the vehicle is a lightweight drone (typically weighing at most a few kilograms), the computing and memory resources and the energy storage capacity are too low for this type of merging.

It could also be conceivable to provide the vehicle with additional sensors to improve navigation accuracy, but this increases the installation cost, decreases the lift capacity and increases the battery consumption requirements; it is not possible in a vehicle with a small overall size and a low lift capacity such as a lightweight drone.

### OBJECT OF THE INVENTION

The object of the invention is to improve the navigation accuracy of a vehicle carrying a LiDAR and an inertial measurement unit as the sole navigation sensors.

### SUMMARY OF THE INVENTION

To this end, according to the invention, a method is provided for navigating a vehicle provided with a LiDAR and an inertial measurement unit, both connected to an electronic navigation unit that implements a first simultaneous localization and mapping algorithm and a second data merging algorithm. As an input, the first algorithm receives first location data from the LiDAR in order to calculate a first displacement from an initialisation position; as an input, the second algorithm receives the first displacement and second location data from the inertial measurement unit and outputs a merged second position of the vehicle. The second algorithm implements invariant extended Kalman filtering, and the merged second position is introduced into a feedback loop which feeds into the first algorithm as an input to calculate a new position, which becomes the initialisation position.

Thus, the method of the invention introduces feedback from the merging algorithm into the simultaneous localization and mapping algorithm. The method is then more robust to sudden changes in direction, which are taken into account by using the second location data from the inertial measurement unit. The merging carried out by the method of the invention therefore has the advantages of loose merging (low calculation cost) but with superior accuracy and robustness. In addition, unlike a standard extended Kalman filter (EKF), the errors of the invariant extended Kalman filter (IEKF) are advantageous in that they are not dependent on the state estimated by the filter, meaning that the feedback does not risk generating cascading errors.

The method also comprises all or some of the following features, either alone or in combination:
the first algorithm determines the first displacement on the basis of the initialisation position and a most recently calculated current position, wherein the feedback loop comprises a calculation block for calculating a relative displacement between the merged position and the most recently calculated current position, and wherein the first algorithm estimates the new position, which becomes the initialisation position, on the basis of the relative displacement and the most recently calculated current position;
the calculation block is a frame change calculation block.

The invention also relates to a vehicle equipped to carry out this method.

Other features and advantages of the invention will become clear on reading the following description of a particular and non-limiting embodiment of the invention.

### BRIEF DESCRIPTION OF THE DRAWINGS

Reference is made to the accompanying drawings, in which:

FIG. 1 is a representation of a first known architecture for merging data from a LiDAR and data from an inertial measurement unit;

FIG. 2 is a representation of a second known architecture for merging data from a LiDAR and data from an inertial measurement unit;

FIG. 3 is a representation of the architecture of the invention for merging data from a LiDAR and data from an inertial measurement unit;

FIG. 4 is a schematic view of a vehicle equipped to carry out the method of the invention.

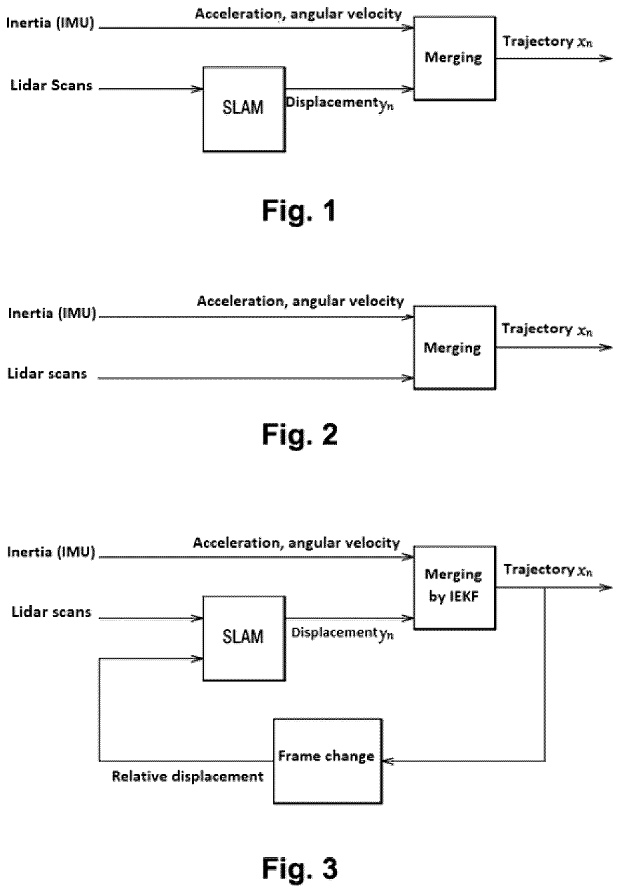

### DETAILED DESCRIPTION OF THE INVENTION

Here, the invention is described in an application for a lightweight drone-type vehicle, such as an aerial drone in this case.

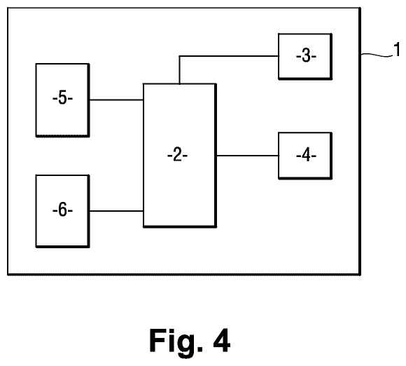

With reference to FIG. 4, a vehicle of this kind, denoted generally by reference numeral 1, comprises, in a manner known per se, a fuselage carrying an electronic control unit 2, a propulsion member 3, a steering member 4, a LiDAR 5 and an inertial measurement unit 6.

The propulsion member 3 comprises, for example, one or more propeller-driven rotors by which the vehicle 1 can take off, hover and move in flight.

The steering member 4 comprises, for example, an actuator for orienting one or more of the rotors, or an actuator for orienting one or more control surfaces for directing the vehicle 1 in flight and modifying its flight path.

The LiDAR 5 comprises a laser emitter and a photodetector that are mounted on a support that can be controlled in terms of its bearing. The laser emitter is arranged to emit laser pulses incident at predetermined bearing angles, and the photodetector detects the laser pulses reflected by obstacles surrounding the vehicle 1. The laser emitter/photodetector assembly scans the vehicle environment (over 360° or a smaller angle, e.g. 180° to the front with reference to a direction of travel of the vehicle 1) such that the signals provided by the LiDAR 5 include the coordinates of all the laser pulse reflection points, which form an image (commonly referred to as a LiDAR scan) of the vehicle environment 1. These coordinates constitute first location data (“LiDAR scans” in FIG. 3). The LiDAR 5 has a sampling frequency dependent on the scanning rate and provides the first location data at that frequency.

The inertial measurement unit 6 comprises three acceleration sensors arranged along the axes of an acceleration measurement reference frame for measuring a specific force in the acceleration measurement reference frame, and three angle sensors (gyros or rate gyros) for measuring angular movements of the acceleration measurement reference frame with respect to a reference orientation of the measurement reference frame. The signals from the inertial measurement unit 6 contain acceleration and angle data, which form second location data (“Inertia (IMU)” in FIG. 3), and are provided at a greater sampling frequency than the frequency at which the first location data representative of a LiDAR scan are provided.

The propulsion member 3, the steering member 4, the LiDAR 5 and the inertial measurement unit 6 are known per se and will not be described further here.

The propulsion member 3, the steering member 4, the LiDAR 5 and the inertial measurement unit 6 are connected to the electronic control unit 2.

The electronic control unit 2 comprises a processor and a memory containing a computer program that can be executed by the processor to carry out the method of the invention in order to perform navigation and control the propulsion member 3 and the steering member 4 so as to autonomously follow the navigation.

The computer program comprises a first simultaneous localization and mapping algorithm (“SLAM” in FIG. 3) and a second data merging algorithm (“Merging by IEKF” in FIG. 3).

Here, the first simultaneous localization and mapping algorithm is a conventional SLAM algorithm which aggregates the LiDAR scans to both map the environment in which the vehicle 1 is moving and also determine the trajectory followed by the vehicle 1 in the environment thus mapped, by detecting the presence of the same points of interest in successive LiDAR scans.

As a first input, the first algorithm receives first location data from the LiDAR 5 in order to calculate a first current position and a first displacement, “yₙ”, between the first current position and a previous position.

As an input, the second algorithm receives the first displacement, “yₙ”, and the second location data from the inertial measurement unit 6 in order to output a merged position of the vehicle 1 and the trajectory, “xₙ”, thereof. The second algorithm implements invariant extended Kalman filtering (IEKF).

The program also implements a feedback loop whereby the position initialising the first algorithm is calculated from the merged position and from the first current position most recently calculated by the first algorithm. More precisely, the feedback loop comprises a “Frame change” calculation block which receives the output of the second algorithm as an input and outputs a second input of the first algorithm; the merged position (from the data provided at the time t, for example) is therefore transferred to the “Frame change” calculation block, which calculates the relative displacement between the merged position (time t) and the first current position (also from the data provided at time t) most recently calculated by the first algorithm. This relative displacement is then sent as an input of the first algorithm. On the basis of the first most recently calculated current position (time t) and the relative displacement, the first algorithm then estimates a new position, which becomes the initialisation position (time t). On the basis of this initialisation position (time t), the first algorithm calculates the first current position and the first displacement at the present time (from the data provided at time t+1), which will be used by the second algorithm to estimate the merged position (time t+1).

It is understood that the advantage of using invariant extended Kalman filtering upstream of the feedback loop is that it avoids the self-feeding of errors since the errors of such filtering are independent of the estimated state, meaning that the errors of this filtering do not feed into the first algorithm, which in turn feeds the second algorithm.

Indeed, note χₙ=(Rₙ,xₙ) as the state of the vehicle, where xₙ is the position of the vehicle in a reference frame and Rₙ is the transfer matrix from the reference frame to the vehicle reference frame (commonly referred to as the orientation). Here, Rₙ is considered to be an orthogonal matrix. Other quantities may be added to this state vector, such as biases of the inertial measurement unit or the velocity, but this is not necessary to explain the invention.

To adjust the filter of the second algorithm IEKF in accordance with FIG. 3, the observation or first displacement yₙ from the first algorithm SLAM is used. As explained above, using the feedback, the SLAM calculates the first displacement yₙ by being initialised at the last position x_{n-τ} it calculated plus the relative displacement between the merged position provided by the second algorithm IEKF, denoted by \hat{x}_{n-τ}, and the last position calculated by the first algorithm SLAM, which corresponds to y_{n-τ}. This results in yₙ, which can be written as a function of its initialisation \tilde{y}ₙ, with the expression \tilde{y}ₙ, namely:

$${\tilde{y}}_{n} = {y}_{n - τ} + {\hat{R}}_{n - τ}^{T} ( {\hat{x}}_{n - τ} - {y}_{n - τ} )$$

In this formula, \hat{R}_{n-τ} is the orientation determined by the second algorithm IEKF and \hat{R}_{n-τ}^{T} denotes its transposed matrix. Here, the observation is equal to the position (to within measurement uncertainties), and so the Kalman filtering implemented in the second algorithm is a left-invariant extended Kalman filter (L-IEKF). Since the observation is equal to the position (to within measurement uncertainties), this results in y_{n-τ}≈x_{n-τ} and thus:

$${\tilde{y}}_{n} = {y}_{n - τ} + {\hat{R}}_{n - τ}^{T} ( {\hat{x}}_{n - τ} - {x}_{n - τ} )$$

The error e_{n-τ} of the invariant Kalman filter L-IEKF can then be identified:

$${e}_{n - τ} = {\hat{R}}_{n - τ}^{T} ( {x}_{n - τ} - {\hat{x}}_{n - τ} )$$

However, for an invariant Kalman filter L-IEKF, it can be shown that the error e_{n-τ} is independent of the estimated state \hat{χ}_{n-τ}=(\hat{R}_{n-τ},\hat{x}_{n-τ}) (also referred to as the “autonomous error”); this result has been demonstrated in the academic literature on the invariant Kalman filter. In particular, the following bibliographical reference can be consulted (in particular proposal 24 therein, which gives the autonomy result of e_{n-τ} used here): “Linear observed systems on groups”, by Axel Barrau and Silvère Bonnabel, published in 2019 in “Systems & Control Letters”, volume 129, pages 36-42.

Thus, the initialisation \tilde{y}ₙ of the first algorithm SLAM for calculating the first displacement yₙ is rewritten:

$${\tilde{y}}_{n} = {y}_{n - τ} - {e}_{n - τ} \qquad \text{(*} )$$

In formula (*), e_{n-τ} does not depend on the estimated state. By applying mathematical induction, in consideration of the fact that at the time n=0 the first initialisation yₙ₋ₜ of the first algorithm SLAM does not depend on the state estimated by the merging (since the merging has not yet started), it can be seen with formula (*) that the initialisation position \tilde{y}ₙ of the SLAM is never dependent on the estimated state, thereby avoiding cascading errors owing to the use of the invariant extended Kalman filter.

It goes without saying that the invention is not limited to the described embodiment but covers any variant falling under the scope of the invention as defined by the claims.

In particular, the structure of the vehicle may be different from that described. It may be an air, land, water or amphibious vehicle and may or may not be piloted.

The LiDAR used here is a 3D LiDAR, but a 2D LiDAR can also be used. Using a 2D LiDAR may be particularly suitable when the invention is applied to a land or water vehicle.

“Linked to” means that the electronic control unit 2 can incorporate the electronic navigation unit (the two electronic units being implemented on the same electronic or integrated circuit) or be connected thereto (the two electronic units being implemented on different electronic or integrated circuits).

1. A method for navigating a vehicle provided with a LiDAR and an inertial measurement unit, both connected to an electronic navigation unit that implements a first simultaneous localization and mapping algorithm and a second data merging algorithm, the first algorithm receiving, as an input, first location data from the LiDAR in order to calculate a first displacement from an initialisation position, the second algorithm receiving, as an input, the first displacement and second location data from the inertial measurement unit and outputting a merged second position of the vehicle, wherein the second algorithm implements invariant extended Kalman filtering and in that the merged second position is introduced into a feedback loop which feeds into the first algorithm as an input in order to calculate a new position, which becomes the initialisation position.

2. The method according to claim 1, wherein the first algorithm determines the first displacement on the basis of the initialisation position and a most recently calculated current position, wherein the feedback loop comprises a calculation block for calculating a relative displacement between the merged position and the most recently calculated current position, and wherein the first algorithm estimates the new position, which becomes the initialisation position, on the basis of the relative displacement and the most recently calculated current position.

3. The method according to claim 2, wherein the calculation block is a frame change calculation block.

4. A vehicle provided with a LiDAR and an inertial measurement unit, both connected to an electronic navigation unit that implements a first simultaneous localization and mapping algorithm and a second data merging algorithm, the first algorithm receiving, as an input, first location data from the LiDAR in order to calculate a first current position and a first displacement between the first current position and a previous position, the second algorithm receiving, as an input, the first displacement and second location data from the inertial measurement unit and outputting a merged position of the vehicle, the electronic navigation unit is programmed to carry out the method according to claim 1.

5. The vehicle according to claim 4, forming a drone, comprising an electronic control unit linked to the electronic navigation unit, a propulsion member and a steering member, which are both connected to the electronic control unit, which is programmed to control the propulsion member and the steering member so as to autonomously follow a trajectory on the basis of the merged positions.

6. The vehicle according to claim 5, forming an aerial drone.

7. The vehicle according to claim 5, forming a land drone.
